(19) United States
(12) Patent Application Publication
(10) Pub. No.: US 2008/0299963 A1
(43) Pub. Date: Dec. 4, 2008

(54) Method and Apparatus for Vocoder Rate Control by a Mobile Terminal

(75) Inventors: Kumar Balachandran, Cary, NC (US); Rajaram Ramesh, Raleigh, NC (US); Havish Koorapaty, Cary, NC (US)

Correspondence Address: COATS & BENNETT, PLLC, 1400 Crescent Green, Suite 300, Cary, NC, 27518, US

(73) Assignee: Telefonaktiebolaget LM Ericsson (publ), Stockholm (SE)

(21) Appl. No.: 11/757,650

(22) Filed: Jun. 4, 2007

(51) Int. Cl. H04Q 7/20

(52) U.S. Cl. 455/422.1

(57) ABSTRACT

A mobile terminal in a wireless communication network detects congestion and lowers its vocoder source rate in response, to help alleviate the congestion. The mobile terminal may detect the congestion in a variety of ways. The mobile terminal may monitor bandwidth allocation in the network, such as by inspecting the UL-MAP and DL-MAP of an IEEE 802.16 OFDM Physical Layer Frame header, for symmetric allocations. Congestion may be defined by the number of symmetric allocations exceeding a threshold. The congestion threshold may be programmed into the mobile terminal, or may be transmitted by the network. The mobile terminal may infer congestion by being repeatedly granted less bandwidth than requested. The network my explicitly indicate congestion, in a MAC message or by setting a congestion flag in one or more voice data frames. The congestion flag may comprise a reserved encoding of the AMR header Frame Type field.

### FIELD OF THE INVENTION

The present invention relates generally to wireless packet data communication systems, and in particular to a method and apparatus for mobile terminal-initiated vocoder source rate control.

### BACKGROUND

A vocoder (voice encoder/decoder) is a circuit that analyzes speech and generates digital data representing the speech, and inversely receives digital data representing speech and synthesizes the speech. Vocoders are employed at either end of a communication system that transmits speech in data packets. Voice over Internet Protocol (VoIP) is typically employed as a means of transporting speech in such applications.

The Adaptive Multirate (AMR) standard specifies vocoders capable of encoding speech at a plurality of data rates, referred to herein as the vocoder source rate. Two variants of AMR exist—narrowband AMR and wideband AMR.. Narrowband AMR includes eight modes with different vocoder source rates, from 12.2 kbps down to 4.75 kbps. This provides the traditional audio bandwidth of PSTN telephony of about 100-3500 Hz. AMR-WB includes nine modes with vocoder source rates from 6.6 kbps up to 23.85 kpbs, providing an audio bandwidth of 50-7000 Hz. In either AMR variant, a vocoder source rate is selected, possibly based on a measurement of channel quality (C/I, BER, FER, etc.). When the channel quality is high, a high vocoder source rate is selected, thereby improving perceived speech quality. When the channel quality is low, such as in the presence of interference, a lower vocoder source rate is selected, and a higher level of error correction coding is applied. The lower rate vocoder may reduce the absolute maximum speech quality that can be achieved, but the resultant speech quality in the presence of channel impairments is typically better than that achieved when using a higher rate vocoder with a lower level of channel coding. Due to this adaptability, AMR vocoders are standardized by 3GPP for GSM and WCDMA wireless communication systems. Furthermore, AMR vocoders are expected to be used for VoIP telephony in many modern and future wireless communication networks, such as High Speed Packet Access (HSPA), 3GPP Long-Term Evolution (LTE) and networks based on the IEEE 802.16 standards (known in the art as WiMAX).

While conventional AMR vocoders are typically adapted to changes in channel quality, the change of vocoder rate as a mechanism for lowering congestion in a packet data network has not been considered in any prior art.

### SUMMARY

According to one or more embodiments described and claimed herein, a mobile terminal in a wireless communication network detects congestion and lowers its vocoder source rate in response to the congestion. The mobile terminal may detect the congestion in a variety of ways.

One embodiment relates to a method of adaptive vocoder source rate control by a mobile terminal in a wireless communication network implementing digital voice telephony. Congestion in the wireless communication network is detected by a mobile terminal. A vocoder source rate is selected by the mobile terminal based on the congestion.

Another embodiment relates to a wireless communication mobile terminal. The mobile terminal includes a transceiver and a variable rate vocoder operative to synthesize digital data representing speech at a plurality of data rates and provide the digital data to the transceiver for transmission to a wireless communication network. The mobile terminal further includes a Media Access Control (MAC) layer processing circuit operative to detect congestion in the wireless communication network, and further operative to direct the vocoder to alter its source data rate in response to the congestion.

Still another embodiment relates to a MAC layer processing circuit in a wireless communication network mobile terminal. The MAC layer processing circuit is operative to detect congestion, and to reduce a vocoder source rate in response to the congestion.

### BRIEF DESCRIPTION OF THE DRAWINGS

FIG. 1 is a functional block diagram of a wireless communication network.

FIG. 2 is a diagram of a representative OFDM Physical Layer Frame.

FIG. 3 is a flow diagram of a method of adaptive vocoder source rate control by a mobile terminal in a wireless communication network implementing digital voice telephony.

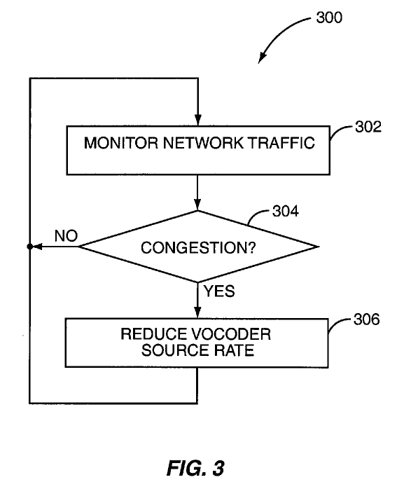

### DETAILED DESCRIPTION

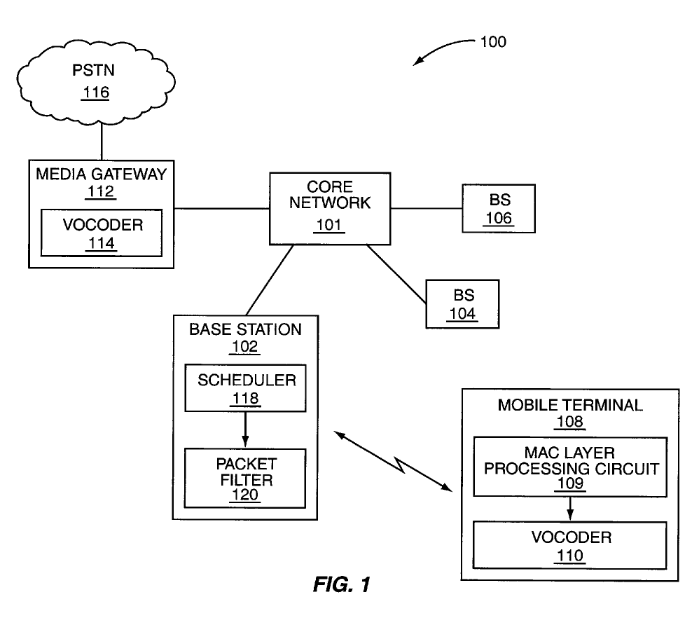

FIG. 1 depicts a wireless communication network 100. A Core Network (CN) 101 controls a plurality of base stations 102, 104, 106, also known in the art as network Access Points (AP). The base station 102 provides wireless voice and data communications with a subscriber mobile terminal 108. The mobile terminal 108 includes a Medium Access Control (MAC) layer processing circuit 109 and a vocoder 110 for encoding and synthesizing speech transmitted between the mobile terminal 108 and nodes in the wireless communication network 100 in a digital format.

The Core Network 101 additionally connects to a Media Gateway 112, which in turn connects to one or more external networks 116, such as the Public Switched Telephone Network (PSTN) or the Internet. The Media Gateway 112 is a transcoding point in the network 100, translating content between various formats in the external networks 116 and the digital format employed by the wireless communication network 100. The Media Gateway 112 includes a vocoder 114 for encoding and synthesizing speech transmitted between the external network 1 16 and the wireless communication network 100 in a digital format.

According to one or more embodiments, the base station 102 includes a scheduler 118 that allocates radio resources among local users requesting communication services. The scheduler 1 18 may allocate resources to users according to a wide variety of criteria, such as the requested Quality of Service (QoS) level, knowledge of the type of content to transfer, current base station 102 utilization, channel quality, and the like.

In one embodiment, the wireless communication network 100 conforms to the IEEE 802.16 specification, known in the art as WiMAX (Worldwide Interoperability for Microwave Access). The WiMAX MAC uses a scheduling algorithm wherein mobile terminals 108 and other subscribers arbitrate for initial entry into the network. After that, each active mobile terminal 108 or other subscriber that is scheduled is allocated a transmission resource by the scheduler 1 18. The transmission resource can be allocated on a dynamic basis, and its size can also change. Each mobile terminal can expect to receive many transmission resources in order to fulfill its needs for data transfer. The scheduling algorithm allows the base station 102 to meet QoS requirements by balancing the transmission resource assignments among the application needs of the mobile terminals 108 and other subscribers. The mobile station 108 may send bandwidth requests to the base station 102 in order for the scheduling algorithm to allocate resources to the mobile station accordingly. In addition, the base station may use knowledge of the channel quality from/to the mobile station in order to determine resources that take the channel coding needs into account.

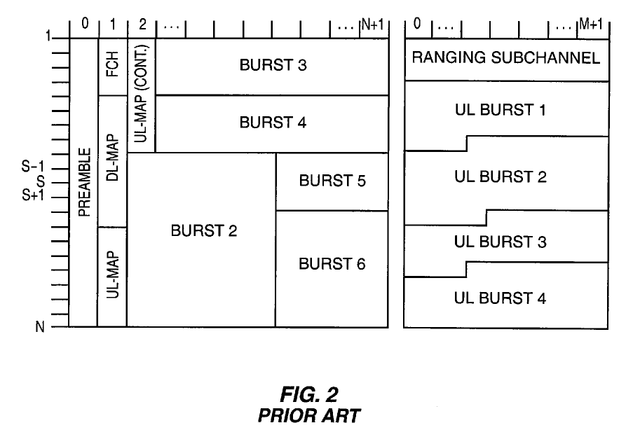

WiMAX utilizes Orthogonal Frequency Domain Multiplexing (OFDM). FIG. 2 depicts a representative WiMAX Physical Layer Frame structure, with time slots along the horizontal axis and OFDM subcarriers along the vertical axis. The downlink and uplink sub-frames may be Time Division Duplex (TDD), as shown, or may be simultaneously transmitted in different frequency bands in a Frequency Division Duplex (FDD) system. In either case, both of the downlink and uplink sub-frames may vary in length, under the control of the scheduler 118. The Physical Layer Frame begins with a Preamble and the Frame Control Header (FCH), followed by downlink and uplink resource allocation maps, DL-MAP and UL-MAP, respectively. The FCH carries a DL frame prefix message that conveys important parameters regarding the frame structure and the modulation and coding parameters used for the DL-MAP and UL-MAP. The UL-MAP and DL-MAP specify the position within the respective uplink and downlink sub-frames of packet data bursts allocated to different mobile terminals 108 or other subscribers. In practice, the MAC layer processing circuit 109 in each mobile terminal 108 scans the UL-MAP and DL-MAP for its own identifier, and transmits or extracts, respectively, data packets from the assigned subcarriers at the appropriate time. Thus, a transmission resource consists of a set of subcarriers for a given amount of time.

According to one embodiment, the MAC layer processing circuit 109 in a mobile terminal 108 also analyzes the UL-MAP and DL-MAP to detect congestion. In particular, the MAC layer processing circuit 109 may detect the number of symmetric allocations (that is, substantially equal bandwidth in the uplink and downlink directions assigned to the same subscriber within a certain period (such as 20 msec for AMR) as a proxy for the number of ongoing voice telephony calls. When the number of voice calls exceeds a predetermined threshold, the MAC layer processing circuit 109 directs the vocoder 110 to reduce its source rate. By reducing the vocoder source rate without a concomitant increase in channel coding, the mobile terminal 108 reduces its bandwidth requirement, thus helping to ease network congestion. By having individual mobile terminals 108 each reduce slightly the quality of their voice communications by a lower vocoder source rate, the network 100 can improve overall service by admitting more users. The mobile station 108 can also communicate a lower bandwidth requirement in future bandwidth requests from the base station 102.

In one embodiment, the congestion threshold at which the mobile terminal 108 reduces its vocoder source rate is programmed into the mobile terminal 108, such as during a periodic software upgrade. In one embodiment, the base station 102 transmits the congestion threshold to the mobile terminal 108, such as in a MAC message or service control function.

In one embodiment, the scheduler 118 signals a network congestion state to the mobile terminal 108 by repeatedly granting the mobile terminal 108 fewer resources than requested (but sufficient resources to transmit voice frames if encoded at a lower vocoder source rate). The mobile terminal 108 deduces the network congestion condition from being granted fewer air interface resources than it requested, and reduces its vocoder source rate, without increasing channel coding, to help alleviate the congestion.

In one embodiment, a packet filter 120 at the base station 102, receiving congestion information from the scheduler 118, intercepts voice data frames between the vocoders 110, 114, and writes a congestion flag, e.g., as a currently reserved (in the AMR specification) Frame Type field in the frame header. The congestion flag gives the mobile terminal 108 (and, in the other direction, the media gateway 112) an explicit notice of network congestion, allowing the mobile terminal 108 to adjust its vocoder source rate more rapidly than, for example, if the mobile terminal 108 were experiencing poor channel quality.

While described herein with respect to WiMAX and OFDM, the present invention is not limited to a wireless communication network 100 utilizing that standard, but rather may be advantageously applied to any wireless communication network 100 implementing voice telephony service. As those of skill in the art will readily recognize, both the MAC layer processing circuit 109 and the vocoder 110 in the mobile terminal 108 (as well as the scheduler 118 and the packet filter 120 in the base station 102) may be implemented as dedicated hardware, as software programs executing on one or more controllers such as a microprocessor, digital signal processor, or the like, or may comprise any combination of hardware, software, and firmware, such as an FPGA, ASIC, or the like.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of adaptive vocoder source rate control by a mobile terminal in a wireless communication network implementing digital voice telephony, comprising:
detecting, by a mobile terminal, congestion in the wireless communication network; and
selecting, by the mobile terminal, a vocoder source rate based on the congestion.

2. The method of claim 1 wherein detecting voice telephony congestion comprises monitoring bandwidth allocation in the wireless communication network and analyzing the bandwidth allocation to detect congestion.

3. The method of claim 2 wherein monitoring bandwidth allocation in the wireless communication network comprises monitoring a periodic report of bandwidth allocated to each subscriber served by a network access point.

4. The method of claim 3 wherein monitoring a periodic report of bandwidth allocated to each subscriber served by a network access point comprises monitoring the periodic report for symmetric bandwidth allocations to subscribers.

5. The method of claim 4 wherein monitoring a periodic report of bandwidth allocated to each subscriber served by a network access point for symmetric bandwidth allocations comprises monitoring a IEEE 802.16 Physical Layer Frame DL-MAP and UL-MAP.

6. The method of claim 1 wherein selecting a vocoder source rate based on the congestion comprises lowering a vocoder source rate if the congestion exceeds a predetermined threshold.

7. The method of claim 6 wherein the predetermined threshold is programmed into the mobile terminal.

8. The method of claim 6 wherein the predetermined threshold is transmitted to the mobile terminal by the wireless communication network.

9. The method of claim 1 wherein detecting congestion comprises receiving lower bandwidth allocation from the wireless communication network than requested.

10. The method of claim 1 wherein detecting congestion comprises receiving a congestion message from the wireless communication network.

11. The method of claim 1 wherein detecting congestion comprises receiving a congestion flag in a voice data frame from the wireless communication network.

12. The method of claim 10 wherein the congestion flag comprises a reserved encoding of Frame Type bits in the voice data frame header.

13. A wireless communication mobile terminal comprising:
a transceiver;
a variable rate vocoder operative to synthesize digital data representing speech at a plurality of data rates and provide the digital data to the transceiver for transmission to a wireless communication network; and
a MAC layer processing circuit operative to detect congestion in the wireless communication network, and further operative to direct the vocoder to alter its source data rate in response to the congestion.

14. The mobile terminal of claim 13 wherein the MAC layer processing circuit detects congestion in the wireless communication network by monitoring bandwidth allocation in the network.

15. The mobile terminal of claim 14 wherein the MAC layer processing circuit monitors bandwidth allocation in the network by monitoring symmetric allocations of bandwidth.

16. The mobile terminal of claim 15 wherein the MAC layer processing circuit monitors symmetric allocations of bandwidth by inspecting the UL-MAP and DL-MAP message of an IEEE 802.16 OFDM Physical Layer Frame.

17. The mobile terminal of claim 15 wherein the MAC layer processing circuit detects congestion if the number of symmetric allocations of bandwidth exceeds a threshold.

18. The mobile terminal of claim 17 further comprising memory and wherein the congestion threshold is programmed into the memory.

19. The mobile terminal of claim 17 wherein the congestion threshold is received by the transceiver from the wireless communication network.

20. The mobile terminal of claim 14 wherein the MAC layer processing circuit monitors bandwidth allocation in the network by comparing the bandwidth granted to it by a scheduler in the wireless communication network to the bandwidth it requested.

21. The mobile terminal of claim 14 wherein the MAC layer processing circuit monitors bandwidth allocation in the network by inspecting voice data frames received by the transceiver for a congestion flag.

22. The mobile terminal of claim 21 wherein the voice data frames comply with the AMR specification, and wherein the congestion flag comprises a reserved encoding of Frame Type bits in the AMR data frame header.

23. A Media Access Control layer processing circuit in a wireless communication network mobile terminal, comprising:
a MAC layer processing circuit operative to detect congestion, and to reduce a vocoder source rate in response to the congestion.

24. The MAC layer processing circuit of claim 23 wherein the MAC layer processing circuit detects congestion by monitoring bandwidth allocation in the network.

25. The MAC layer processing circuit of claim 24 wherein the MAC layer processing circuit monitors bandwidth allocation in the network by monitoring symmetric allocations of bandwidth.

26. The MAC layer processing circuit of claim 25 wherein the MAC layer processing circuit monitors symmetric allocations of bandwidth by inspecting the UL-MAP and DL-MAP message of an IEEE 802.16 OFDM Physical Layer Frame.

27. The MAC layer processing circuit of claim 25 wherein the MAC layer processing circuit detects congestion if the number of symmetric allocations of bandwidth exceeds a threshold.

28. The MAC layer processing circuit of claim 27 further comprising memory and wherein the congestion threshold is programmed into the memory.

29. The MAC layer processing circuit of claim 27 wherein the congestion threshold is received by the transceiver from the wireless communication network.

30. The MAC layer processing circuit of claim 24 wherein the MAC layer processing circuit monitors bandwidth allocation in the network by comparing the bandwidth granted to it by a scheduler in the wireless communication network to the bandwidth it requested.

31. The MAC layer processing circuit of claim 24 wherein the MAC layer processing circuit monitors bandwidth allocation in the network by inspecting voice data frames received by the transceiver for a congestion flag.

32. The MAC layer processing circuit of claim 31 wherein the voice data frames comply with the AMR specification, and wherein the congestion flag comprises a reserved encoding of Frame Type bits in the AMR data frame header.
